(19) United States
(12) Patent Application Publication
(10) Pub. No.: US 2012/0029969 A1
(43) Pub. Date: Feb. 2, 2012

(54) RISK MANAGEMENT OF BUSINESS PROCESSES

(76) Inventors: JOERN FRANKE, Mougins (FR); Wihem Arsac, Biot (FR)

(21) Appl. No.: 12/846,883

(22) Filed: Jul. 30, 2010

(51) Int. Cl. G06Q 10/00

(52) U.S. Cl. 705/7.28

(57) ABSTRACT

Various embodiments of systems and methods for risk management of business processes are described herein. A system integrating process monitoring and automated risk management through a risk-annotated business process model is described. Such a risk would be computed for each of the possible path of execution of the business process. The source of such a data can be derived from other systems or be entered manually. A risk prediction rule is executed when a given event has happen. Depending on the current execution state of a business process instance, the risk is calculated from the probability and the impact. If the risk is over a certain threshold, some actions can be taken (e.g., stopping processes, initiate mitigation processes or notifying the business process owner).

### FIELD

Embodiments of the invention generally relate to the software arts, and, more specifically, to methods and systems for risk management of business processes.

### BACKGROUND

Business Process Monitoring (BPM) and Risk Management (RM) have become an important topic in today's economy. Both are required to deal with a dynamic environment so as to manage agile processes. Those approaches are currently poorly integrated and lead to cumbersome manual efforts, making the risk management more difficult, error-prone and cost-intensive. Risk management is the identification, assessment, and prioritization of risks to minimize, monitor, and control the probability and impact of unexpected events. Risks can come from uncertainty in financial markets, project failures, legal liabilities, credit risk, accidents, natural causes and disasters as well as deliberate attacks from an adversary. Several risk management standards have been developed including the Project Management Institute, the National Institute of Science and Technology, and ISO standards. The strategies to manage risks include transferring the risk to another party, avoiding the risk, reducing the negative effect of the risk, and accepting some or all of the consequences of a particular risk.

Risk management should be part of organizational processes and decision making. It should explicitly address uncertainty and take into account human factors. Risk management should be dynamic, iterative, and responsive to changes as well as to be capable of continual improvement and enhancement. Further, the risk management should be systematic and structured and based on the best available information. According to the standard ISO 31000 “Risk management—Principles and guidelines on implementation”, the process of risk management consists of the following steps: 1) establishing the context—including identification of the risk, planning, defining a framework, developing an analysis, solution of the risk; 2) identification—identifying potential risks via objectives-based risk identification, scenario-based risk identification, taxonomy-based risk identification, common-risk checking, and risk charting; and 3) assessment—assess identified risks to their potential severity of loss and to the probability of occurrence.

### SUMMARY

Various embodiments of systems and methods for risk management of business processes are described herein. In an embodiment, the method includes receiving an initiating event from a monitoring unit for risk evaluation. The method further includes determining a risk event from a risk management rule for the initiating event. Further, for a plurality of process models, where the risk event can happen in future, a plurality of instances of a process model from the plurality of process models is determined For the plurality of instances of the process model, a position of the risk event in an instance of the process model is located and a risk for the position of the risk event is calculated. In addition, the calculated risk is compared against a threshold defined in the risk management rule. Finally, in response to the compared calculated risk, the risk management rule is executed.

In an embodiment, the system includes a monitoring unit to monitor an event and send the event for risk evaluation. The system also includes a process engine that provides a set of probabilities for the event to happen defined manually or automatically. Further, a risk management engine is included to perform the risk evaluation on the event following a process model, wherein the risk management engine defines and executes a risk management rule on the event and calculates risk for the event based on the set of probabilities and an impact of the event. The system also includes a reaction engine to react on the event based on the risk calculation and an action defined in the risk management rule.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an architectural view of a risk management system according to an embodiment.

FIG. 2 is a block diagram illustrating the functionalities of the risk management engine at design time and at runtime.

FIG. 3 is a block diagram illustrating basic elements of a process model.

FIG. 4 is a flow diagram illustrating a business process example including a risk management process.

FIG. 5 is a flow diagram illustrating the process for executing a risk management rule, according to an embodiment.

FIG. 6 is a flow diagram illustrating the process of calculating risks for a given process instance, according to an embodiment.

FIG. 7 is a flow diagram illustrating the process of calculating risk probabilities for an event, according to an embodiment.

FIG. 8 is a block diagram illustrating an example of a process model.

FIG. 9 is a block diagram illustrating an example of an instance of process model with two states at the same time.

FIG. 10 is a block diagram illustrating an exemplary computer system 1000.

### DETAILED DESCRIPTION

Embodiments of techniques for risk management of business processes are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiment.

Managing the risk of agile business processes in a dynamic environment is of key importance for companies all over the world. The National Institute of Standards and Recommendations (NIST) has recommended guidelines for evaluating the risk of information technology. However, existing projects and approaches still face important limitations. For example, the case of the bank Kreditanstalt für Wiederaufbau (KFW) cannot be solved with existing approaches. In this case the bank transferred half a billion (536 Million) Euro to the Lehman bank—at the same day Lehman bank went officially bankrupt. Many other examples show that the risk management needs to be supported by systems—not only in crisis time, but also in normal times. An approach that manages the risk of process execution (e.g., transfer of half a billion euro to a bankrupt bank) and the reaction (stop the process) would have saved, for this case, a lot of money.

Agile business processes usually involve taking risks while executing them. This is necessary for companies to gain superior margins compared with the market and the existing uncertainties in the market requires taking some risks. The risk R can be described by the following equation: R=I×P, where I is the monetary impact of an event E (it can be negative or positive) and P is the probability the event E to happen. Risks are defined as the probability that an event E will happen combined with the impact (in monetary terms) of that event. This event usually has a negative impact (e.g., costs for the company), but a system is flexible and can also describe positive impacts (“chances”).

The risks are identified at design time of processes and they are handled during the runtime (e.g., stopping processes, cancelling processes, etc.). Doing risk management at runtime manually leads to the following problems: 1) many resources have to be involved in managing risks at the runtime of business processes, this is cost-intensive and error-prone; 2) changed risks profiles (e.g., re-evaluation of risks) cannot easily be integrated in the runtime of processes; 3) risks are managed too late (i.e., processes are not stopped or mitigated in time); and 4) risk management in cross-organizational scenarios lead to increased resource and coordination needs.

In an embodiment, a system is provided that supports an automated risk management based on an economic risk management approach. A business process annotated with probability would enable decision-makers to better manage their risks and to increase thus the margin. These annotations allow evaluating the risk of the current state of a process instance by a risk management engine and taking automatically appropriate actions based on the risk of the state of a process instance (e.g., stopping it).

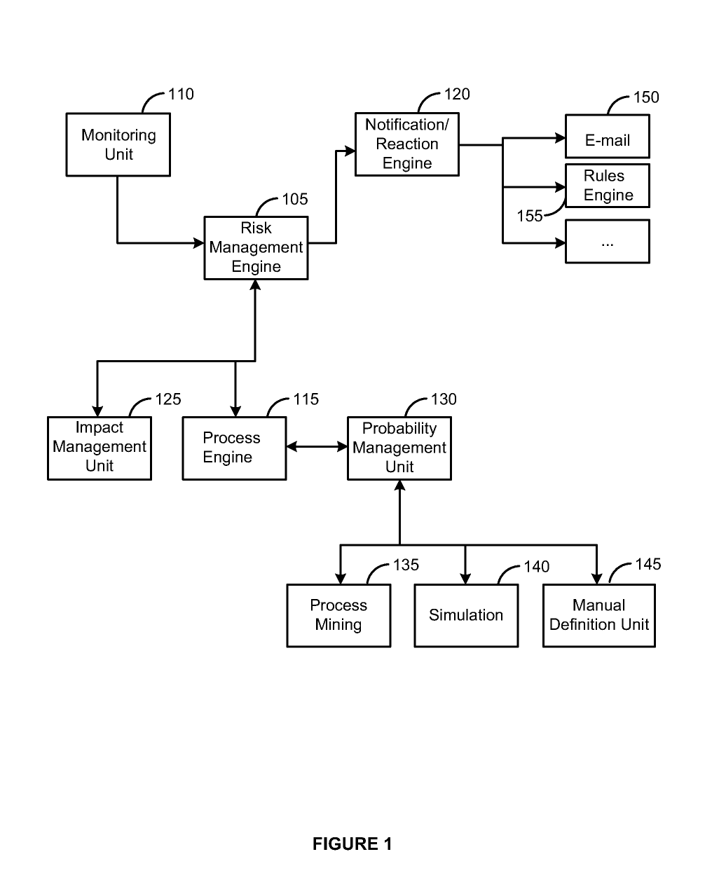

FIG. 1 is a block diagram illustrating an architectural view of a risk management system according to an embodiment. Risk management engine (RME) 105 allows the definition and execution of a plurality of risk management rules. It receives, from the monitoring unit 110 components, events that are part of a risk management rule. The RME 105 uses process engine 115 to calculate the risk of a future event. Further, RME 105 uses notification engine 120 to react to a risk whether it is equal to or above a threshold via sources such as e-mail 150, rules engine 155, and so on.

Monitoring unit 110 is a standard monitoring unit for events. Monitoring 110 sends events in a format that is understandable by the risk management engine 105. Impact management unit 125 relies on a database where the impact of events is stored. For example, the event that a customer does not pay his or her loan has the impact of a loss of 100,000 euro. Probability management unit 130 allows the management of probabilities of events. It can derive the probability of events from a wide range of sources, such as process mining 135 (probability calculated based on previous process executions), simulation 140 (based on formal analysis), and manual definition unit 145 of probabilities. The process models in the process engine 115 have to be annotated with these probabilities.

Notification/Reaction engine 120 allows reaction to risks which are equal to or above a threshold. The actions are defined in the risk management calls. Actions call functionalities of other systems are performed using Web service technology or any other technology allowing exposure of interfaces (CORBA, RFC, etc.).

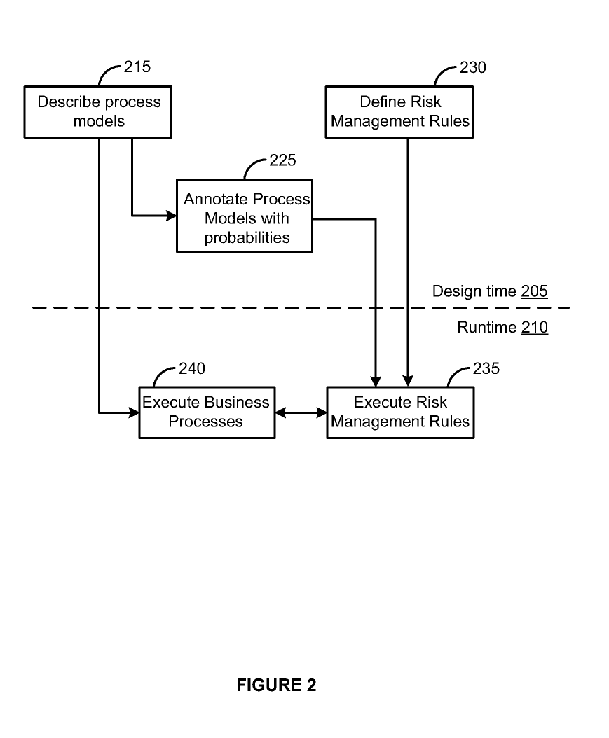

FIG. 2 is a block diagram illustrating the functionalities of the risk management engine at design time and at runtime. The processes of the risk management engine 105 are performed during design time 205 and runtime 210. At design time 205, process models in the process engine 115 are described at block 215. At design time 205, probabilities of events are defined. The probabilities could be defined automatically (e.g., by process mining 135) or manually by manual definition unit 145. The defined probabilities are used to annotate the process models at block 225. At design time 205, the risk management rules describing the risks, their impact, and how to react on them are defined at block 230. During runtime 210, the risk management rules are executed at block 235. Using the risk management rules, the business processes are executed as well at block 240.

In an embodiment, a business process (BP) can be modeled as a flow of activities that have to be realized to achieve a business goal. These activities may be split into a set of tasks, executed by resources (human or software agents). Human tasks may be carried out by several business participants according to their organizational roles within the process. The assignment of a role to a business participant provides the participant with the authorizations needed to fulfill specific tasks. As resources (i.e., business participants) are often external and dynamic, they are of importance in the workflow correctness. From a business analyst's perspective, one first needs to make the distinction between the model and the instance of a process. A process model is a formalized view of a business process, represented as a set of activities that are connected in a directional graph to achieve a common goal, whereas an instance is the representation of a single enactment of a process. Each instance represents a separate thread of execution of the process. A process instance can be described as a process model with the current task(s) that need to be executed.

Among the several languages and notations that model a business process, BPMN (Business Process Modeling Notation) and UML (Unified Modeling Language) can be considered as the main standards. In an embodiment, the business process is modeled in BPMN, since it offers a graphical notation, which is easy to understand for modelers and easily extensible. BPMN also emphasizes on control-flow.

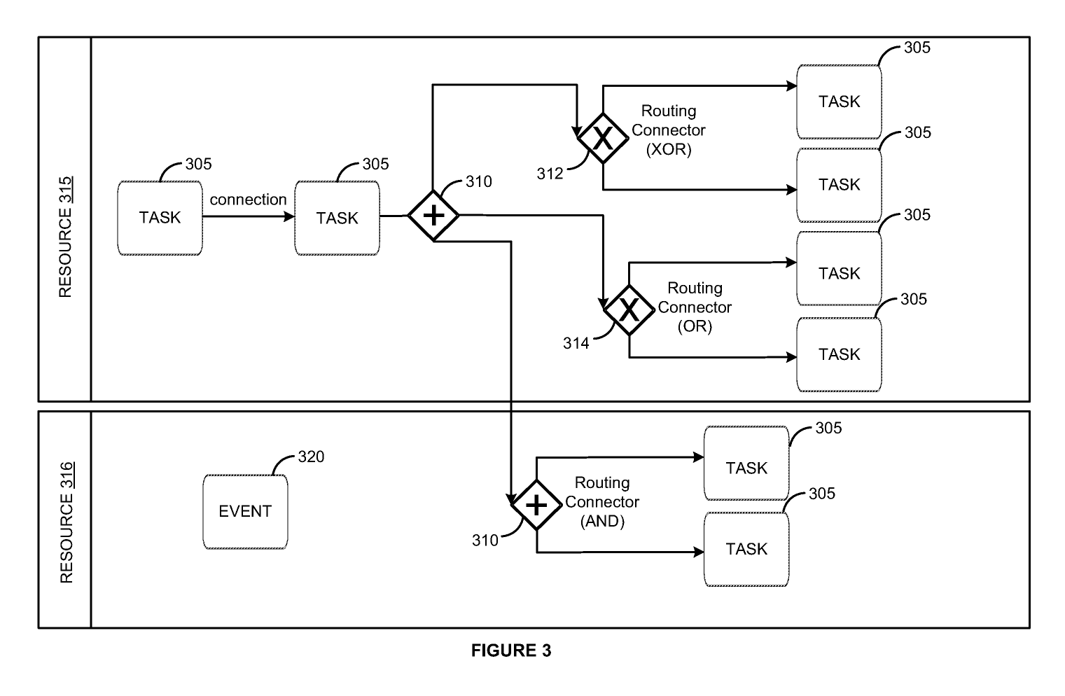

FIG. 3 is a block diagram illustrating basic elements of a process model. A process in BPMN is a graph of flow elements that are a set of activities, events, gateways, and sequence flows that define finite execution semantics. The process model can include process flows and sequence flows. The process flow is chronological and the sequence flow represents the sequence order of activities that are executed within a business process. A business process includes a set of activities that define the work performed within the BP. An activity can be decomposed into several sub-processes, which contribute to achieving the goal of the super-process or atomic task. There may be manual activities, which do not support computer automation, or automated activities. Activities may be executed by business participants. A task, such as task 305, is a piece of work that forms an atomic logical step within a process. Connections are defined between tasks (to describe the sequence flow), or between business participants (to define the message flow), and also between tasks and data (defined as association).

Routing elements (gateways) control the flow of the process. A decision mechanism, such as routing connector 310, 312, and 314, should determine whether the process flow would be a branching, forking, merging or joining of paths of execution. For instance: 1) AND connector 310—specifies that task sequences are executed in parallel; 2) OR connector 314—specifies that one or more task sequences are selected and executed in parallel; and 3) XOR 312—specifies that one task sequence is selected and executed.

The process model also includes resource units such as resource 315 and 316 and event units such as event 320. The resource unit 315 describes who is performing a given activity. The event unit 320 represents what happens during the execution of tasks of the business process. It represents the occurrence of a particular condition which causes the process to take one or more actions. It should be appreciated that although the BPMN is used to describe the process model, other business process modeling languages basically cover the same concepts and thus they can also be applied.

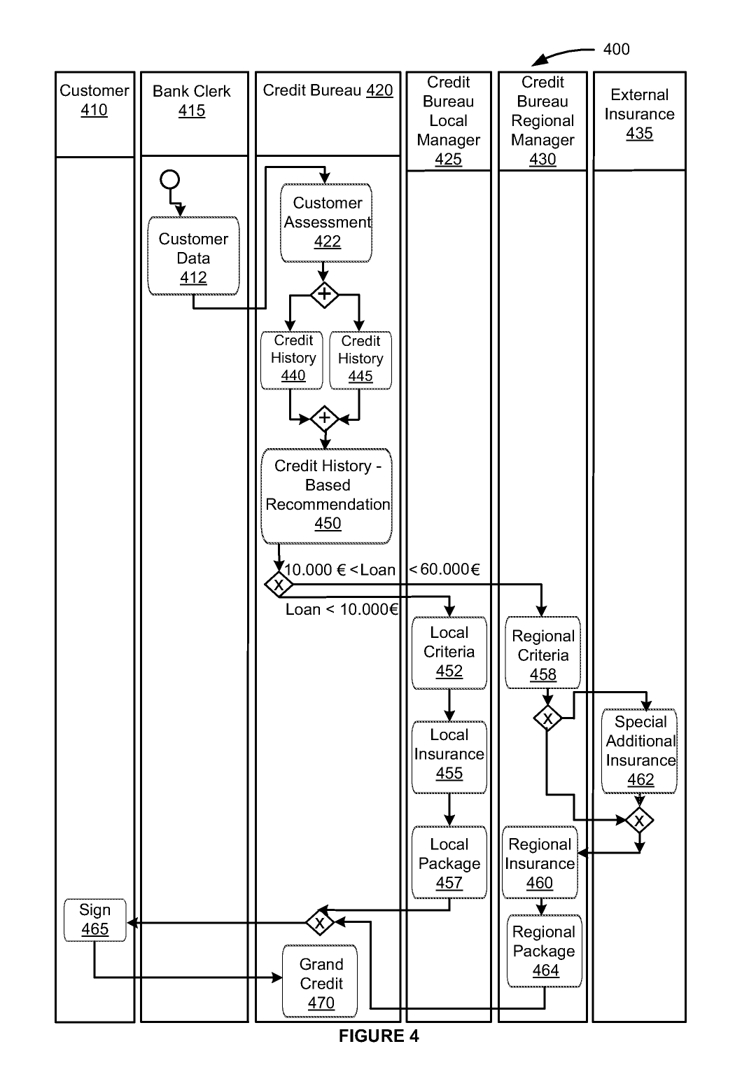

FIG. 4 is a flow diagram illustrating a business process example including a risk management process. Process 400 shows a Loan Origination Business Process (LOBP) banking scenario. It should be appreciated that risk management can be applied to different types of scenarios including, but not limited to banking scenarios, supplier management, supply chain management, outsourcing processes, etc.

In an embodiment, business process 400 formalizes, evaluates, and possibly accepts a customer 410 request for a loan amount. The bank clerk 415 carries out a careful evaluation of the customer's credit worthiness through internal mechanisms and by asking assurance to external agencies called credit bureaus 420. A credit bureau is a third party business partner of a financial institution that processes, stores, and safeguards credit information of physical individuals or industrial companies. Credit bureaus 420 gather data from various sources and cross-check and match the data for accuracy. Some of these sources include publicly available records (courts and deeds offices) and credit account details (from credit granters or subscribers). Besides the external third party credit bureau 420, there may be some credit bureau units inside the bank to further check the customer's data, such as credit bureau of local manager 425 and credit bureau of regional manager 430. Credit granters in turn are companies such as banks, retailers and any other organizations whose business is credit. They are also called “subscribers” because they subscribe to the credit bureau in order to collect, submit, use and share the information held in the database management systems. They use the information from the credit bureau to make decisions on whether or not to grant credit, in terms of their own credit granting policies. External insurance 435 can provide additional insurances for the credit.

Referring to the exemplary scenario at FIG. 4, bank clerk 415 enters customer data 412 in a risk management system. The customer data is transferred to a credit bureau 420 to do customer assessment 422. Based on credit history 440 and 445, the credit bureau 420 creates credit history-based recommendation 450. As the routing connector of customer assessment 422 to credit history 440 and 445 is AND, then both credit history check tasks are performed in parallel. From the credit history-based recommendation 450, there are two possible scenarios represented with XOR connector. One scenario leads to the local manager of the credit bureau (or bank) 425 and the other scenario leads to the regional manager of the credit bureau (or bank) 430. The XOR connector provides the possibility for selecting and executing one of the two scenarios. The local manager of the credit bureau (or bank) 425 and the regional manager of the credit bureau (or bank) 430 perform additional checks according to some criteria such as local criteria 452, local insurance 455, local package 457, regional criteria 458, regional insurance 460, regional package 464, special additional insurance 462, and so on. The result from these checks from the selected scenario (local manager 425 or regional manager 430) is returned back to credit bureau 420. Based on the result of the risk management process, the credit bureau 420 either sends the customer the formal papers for the loan to sign 465 or declines the loan request. After the customer signs the papers, the credit is granted 470 from the credit bureau 420.

In another exemplary scenario, a customer named John is a single 25 years old man. Recently, John was appointed as teacher on a permanent contract. His gross salary is about 25,000 EUR per year. At the moment, John's account exhibits a positive balance of 10,000 EUR. Therefore, John decides to apply to his bank for a loan of 90,000 EUR to buy a real estate property. On the basis of John's positive records, it seems fair to expect that the bank will grant him the loan, as shown in business process 400. Let imagine that an event has happened that the credit worthiness of the customer John has changed. John has just contracted a leasing within a car company. The credit bureau 420 would not return anymore an approval for a loan request. For each of these process instances, there is a need to evaluate the risk of the current execution and take appropriate actions. For the sake of simplicity, this is done manually with the following limitations: 1) manual calculation of risk is resource intensive and sometimes impossible (e.g., 1000 instances of a process/day and distributed over several subsidiaries); 2) it is not known how actions can be taken, because the interfaces to the systems are not clear; 3) action cannot be taken in time, because manual action consume time (find out who is responsible for the system/process/etc., contacting him/her, deciding on appropriate actions); and 4) environment may change (in this case economic environment), which leads to re-evaluation of risks.

In an embodiment, a risk management engine 105 is included in the business process system that allows the definition and execution of a plurality of risk management rules. A risk management rule has the following components: 1) an initiating event—specifies an event that has been monitored by the monitoring infrastructure and which is forwarded to the risk management engine, it can be generated by existing process instances, but also be any environmental event; 2) a risk event—specifies an event that is part of a process model from which process instances have been created, it is a future event that might happen; 3) a threshold—specifies the threshold of a risk (e.g., >10.000 Euro) when appropriate actions should be taken; and 4) an action—specifies the action that should be taken, it describes an interface to a system (e.g., e-mail, process engine 115, and so on) that can be accessed to execute the action.

An event can be defined with the following equation: E=(T, A, D, R, S), where T is the event type, A is the activity generating the event and the following optional descriptions: D is the data associated with the event/activity (e.g., an invoice in XML); R is a resource associated with the event/activity (e.g., “user104854”); and S represents the systems/services associated with the event/activity (e.g., “SAP ERP FI”). The optional descriptions might imply different probabilities (e.g., if one says resource “user104854”, then there is a different probability as if someone says all users).

A risk event can be described in the following forms: 1) event(X)—means that event(X) will happen (in the future); 2) NOT event(X)—means that event(X) will not happen; and 3) event(X) OR event(Y)—means that event(X) or event(Y) will happen and combination of both events. A risk event also contains the impact of the event in monetary terms (e.g., 10.000 Euro). The risk event refers to an activity/task in the business process model.

The threshold in a risk management rule is a numerical value and it can be defined as smaller or greater to a given risk value (e.g., 10.000 Euro). An action in a risk management rule represents a system call through an interface (e.g., using Web service technology, J2EE, CORBA, etc.) or the execution of a task. An exemplary risk management rule that can be applied to the loan origination process has the following definition:

Initiating event: Creditworthiness of customers has been re-evaluated

Risk event: Granting Credit

Threshold: All credits of >1000 Euro

Impact: 100.000 Euro

Action: Stop Processes

As part of the risk management process, the process models need to be annotated with probabilities and impact that an event in the future will occur. This annotation can be done manually or automatically. In an embodiment, the process models are algorithmically annotated, so that a manual or automated annotation can take place, in the following way: 1) annotate each outgoing transition of a XOR gateway with a probability P; and 2) annotate the outgoing transitions of an AND gateway with probability 1. The OR gateway can be simulated by using AND and XOR gateway in combination. The reason to do it this way is, because the OR gateway can have several different underlying semantics and makes it applicable to many different scenarios. In an embodiment, cycles are not allowed in process models, because this makes it very difficult to calculate risks. However, sequences containing cycles can be described as one activity, which represents the whole activity sequence (i.e., the cycle is represented as a black box). This resolves the limitation in many cases.

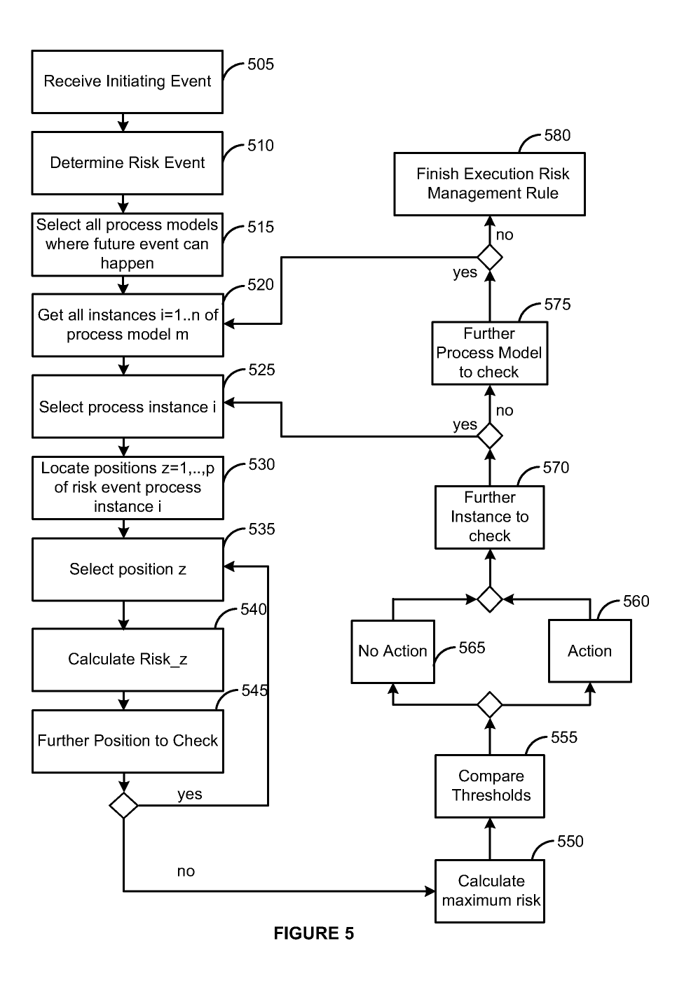

FIG. 5 is a flow diagram illustrating the process for executing a risk management rule, according to an embodiment. An event has been monitored and transferred to the risk management engine 105 for processing. At block 505, an initiating event is received from a monitoring unit. The RME 105 checks if one or more risk management rules exist for that event. At block 510, a risk event is determined from the risk management rule for the event. The one or more risk management rules have been defined during design time. At block 515, all process models (m=1 . . . j) where the event can happen in future are selected. At block 520, all instances (i=1 . . . n) of a process model (m) are obtained. At block 525, the first instance (i) of a process model is selected. At block 530, all positions (z=1 . . . p) of the risk event are located in the first instance (i) of the process model. At block 535, the first position (z) of the risk event is selected. At block 540, the risk is calculated for this position of this instance of this process model. At decision block 545, the process decides if there are more positions for which the risk has to be calculated. If there are, then the process goes back to block 535, where the next position (z) of the risk event is selected. If there are no other positions available, then the process continues at block 550. At block 550, the maximum risk for the current position is calculated. The maximum risk represents the highest value from a given set of risk values (e.g., 1000 euro, 10000 euro, 4000 euro are defined as risk values—the maximum risk is 10000 euro). At block 555, the calculated maximum risk is compared with the threshold defined in the risk management rule. If the risk is above the defined threshold, then the action specified in the risk management rule is performed at block 560. If the calculated risk is below the defined threshold, then no action is taken, at block 565.

At block 570, the process determines if there is another instance of the current process model to be checked. If there is, then the process goes back to block 525, where the next instance (i) of the process model is selected. If there are no other instances available, then the process continues at block 575. At block 575, the process determines if there is another process model to be checked. If there is, then the process goes back to block 520, where all instance (i) of the next process model (m) are obtained. If there are no other process models available, then the process of executing a risk management rule finishes at block 580.

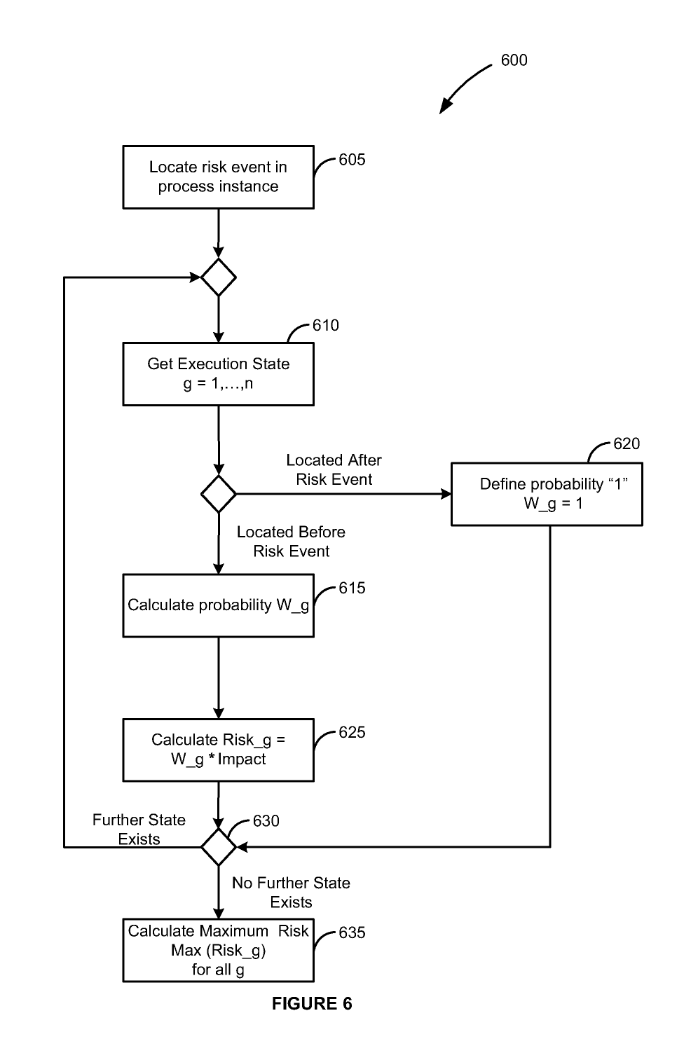

FIG. 6 is a flow diagram illustrating the process of calculating risks for a given process instance, according to an embodiment. At block 605, a risk event is located in an instance of a process model (or simply “process instance”). At block 610, a current execution state (g=1 . . . n) of the event is obtained. The execution state represents a state in the instance of the process model for which a risk may have to be calculated. For example, in process 400, each block (state) may be an execution state, such as 422, 440, 445, 450, and so on, for which a risk management rule has to be executed to calculate the risk at this state. Depending on the current execution state of a business process instance, the risk is calculated from the probability and the impact of the event. As discussed in regard to FIG. 5, after the initiating event has been transferred to the risk management engine for risk evaluation, the RME checks if there are any defined risk management rules for that event. If there are, then from the given risk management rule, the RME determines the risk events and looks for them in the process instances. The risk events may be positioned in different blocks of the process model instance. If the current execution state is located before a risk event, then the process 600 continues at block 615. For example, the current execution state is credit history 440, but the RME has located a risk event at credit history-based recommendation 450. Otherwise, the process 600 continues at block 620. Since, there are two ways to annotate transitions in a process model, there are two possible scenarios included in the process model:1) annotate each outgoing transition of a XOR gateway with a probability P; and2) annotate the outgoing transitions of an AND gateway with probability 1. Thus, since at block 615 the execution state is positioned before the risk event, then the risk event may happen or may not happen. Each process model can have a number of instances and usually there are several instances running at the same time (e.g., several credit rating process instances). For each instance, the risk may happen or not happen, i.e., in some instances the risk happens and in some instances it does not. Therefore, for this case, the process model is annotated with undefined probability P that needs to be calculated. In case the risk event is located before the execution state, then the process model is annotated with probability 1.

At block 615, the probability (W_g) of the risk event to happen is calculated at the obtained execution state at 610. At block 625, the risk for the given execution state is calculated based on the calculated probability and the impact of the event (Risk_g=W_g*Impact). At decision block 630, the process 600 checks if there are more execution states (g). If there is another execution state, then the process 600 is returned to block 610, where the next execution state is obtained. Otherwise, the process 600 continues at block 635. At block 620, where the execution state is in position after the risk event, the probability is defined as “1”. Since, there is no need for probability calculation, the process 600 from block 620 continues at block 630. At block 635, the maximum risk is calculated for all execution states (Max (Risk_g)).

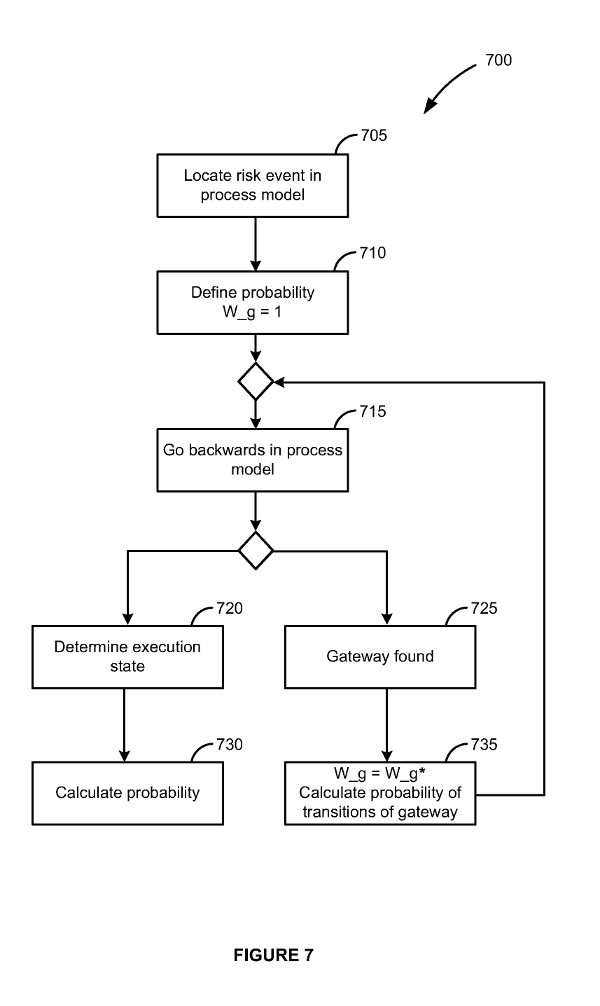

FIG. 7 is a flow diagram illustrating the process of calculating risk probabilities for an event, according to an embodiment. At block 705 a risk event is located in an instance of a process model. Following process 600, if the risk event is located before an execution state of an event, then the probability is defined as “1”. Thus, at block 710, probability of the risk event is defined as “1” (W_g=1). At block 715, the process 700 goes backwards in the process model similarly to following block 620 in process 600. Going backwards in the process model leads to either block 720 or block 725. At block 720, an execution state is determined At block 730, the probability for the risk is calculated. At block 725, process 700 reaches a gateway (a routing connector such as routing connector 310). The gateway may lead to more than one different state with different risk management rules. At block 735, the probability of each outgoing transition of the gateway is calculated.

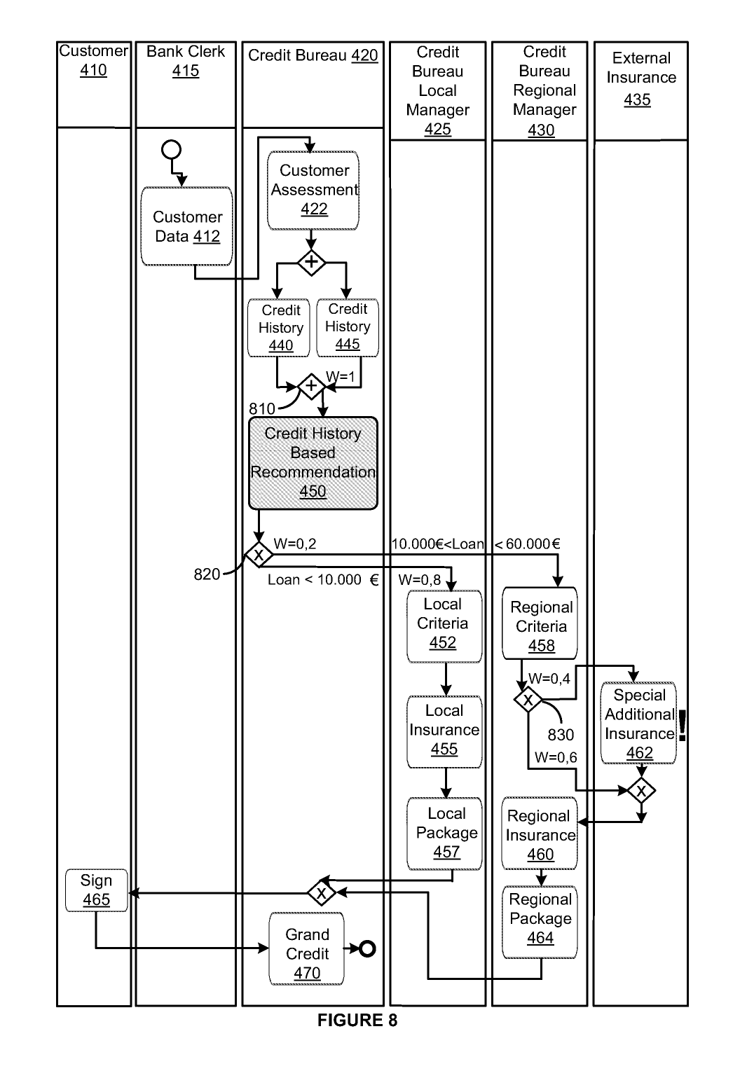

FIG. 8 is a block diagram illustrating an example of a process model. FIG. 8 follows the example provided with FIG. 4. For this example, the following risk management rule is defined:

Initiating event: Rating of insurance has been reevaluated.

Risk event: Special Additional Insurance, 100.000

Threshold: 7.000 Euro

Action: Stop Processes

Similarly to FIG. 4, customer assessment has to be performed by credit bureau 420 based on credit history 440 and 445. The instance of the process model is annotated with probabilities at each gateway (the probabilities are annotated at the outgoing transitions of the gateway). The current execution state of the instance is credit history-based recommendation 450. The first AND gateway 810 is after receiving the assessment based on credit history 440 and 445. The AND gateway (routing connector) means that both credit history 440 and 445 are taken into account. Further, since it is an AND gateway, the gateway has a probability of “1”, W=1. The first XOR gateway 820 has two outgoing arcs with a probability of “0.2” and “0.8” respectively. The probabilities are calculated automatically or manually and provided to the risk management engine. The second XOR gateway 830 has two outgoing arcs with a probability of “0.4” and “0.6” respectively.

Based on the probability values and the risk management rule definitions, the risk can be calculated. First the probability of the instance of the process model is calculated based on the probabilities of the two XOR gateways: W=0.4 (probability of the second XOR-gateway)*0.2 (probability of the first XOR-gateway)=0.08=8%. Then, the risk is: Risk=0.08 (calculated probability)*100,000 (risk event)=8000 Euro. In this case, the process instance (customer request) will be stopped because the risk is higher than the threshold.

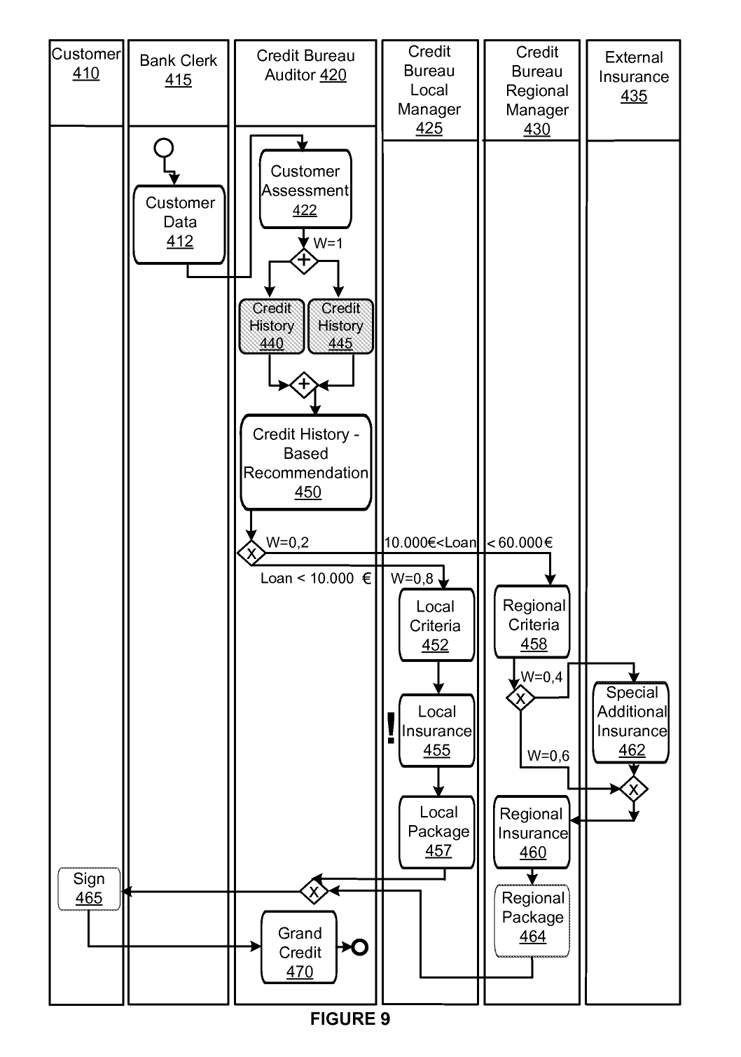

FIG. 9 is a block diagram illustrating an example of an instance of process model with two states at the same time. While in FIG. 8, the current state of the process instance was credit history-based recommendation 450, in FIG. 9 the current states are credit history 440 and 445 at the same time. For this example, the following risk management rule is defined:

Initiating event: Rating of insurance has been reevaluated.

Risk event: Insurance local, 10,000

Threshold: 8,000 Euro

Action: Stop Processes

Similarly to the example of FIG. 8, the risk is calculated: Risk=0.8*10,000=8000.However, in this scenario, the risk is calculated twice (one time for each state). In this case, both times the risk is the same. When there is more than one current state, the maximum risk has to be calculated based on all current states. The maximum risk in this example is: max(8000,8000)=8000 Euro. This is equal to the threshold and in this case the instance would be stopped. It should be noted that different states of a process might also lead to different risks and thus it is important to calculate the maximum risk.

The risk management system provides integrated monitoring and automated risk management process that allows a system to detect and manage risks in time (even in advance) through a risk-annotated business process model. Further, flexible risk rule management that can add new rules or remove old ones in time is provided. Risk detection is based on a solid economic foundation and can integrate already existing systems for describing risks.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

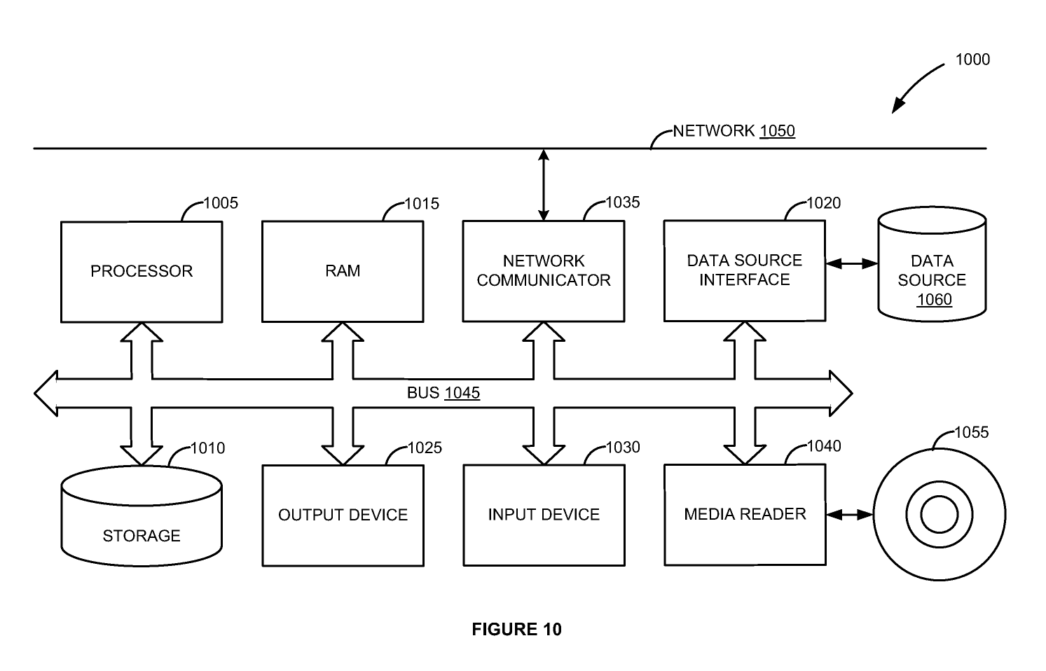

FIG. 10 is a block diagram illustrating an exemplary computer system 1000. The computer system 1000 includes a processor 1005 that executes software instructions or code stored on a computer readable storage medium 1055 to perform the above-illustrated methods of the invention. The computer system 1000 includes a media reader 1040 to read the instructions from the computer readable storage medium 1055 and store the instructions in storage 1010 or in random access memory (RAM) 1015. The storage 1010 provides a large space for keeping static data where at least some instructions could be stored for later execution. The stored instructions may be further compiled to generate other representations of the instructions and dynamically stored in the RAM 1015. The processor 1005 reads instructions from the RAM 1015 and performs actions as instructed. According to one embodiment of the invention, the computer system 1000 further includes an output device 1025 (e.g., a display) to provide at least some of the results of the execution as output including, but not limited to, visual information to users and an input device 1030 to provide a user or another device with means for entering data and/or otherwise interact with the computer system 1000. Each of these output 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be access via one or more abstraction layers implemented in hardware or software. For example, the data source 1060 may be access by network 1050. In some embodiments the data source 1060 may be accessed via an abstraction layer, such as, a semantic layer.

A data source 1060 is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
receive an initiating event for risk evaluation;
determine a risk event from a risk management rule for the initiating event;
for a plurality of process models, where the risk event can happen in future:
determine a plurality of instances of a process model from the plurality of process models;
for the plurality of instances of the process model:
locate a position of the risk event in an instance of the process model;
calculate a risk for the position of the risk event;
compare the calculated risk against a threshold defined in the risk management rule; and
in response to compare the calculated risk, execute the risk management rule.

2. The article of manufacture of claim 1, wherein the instructions further cause the computer to:
determine a first current execution state in the instance of the process model;
calculate probability of the risk event for the first current execution state; and
calculate the risk based on the calculated probability and an impact of the risk event.

3. The article of manufacture of claim 2, wherein the instructions further cause the computer to calculate a maximum risk based on the calculated risk for the first current execution state and the calculated risk for a second current execution state.

4. The article of manufacture of claim 2, wherein execute the risk management rule causes the computer to execute an action defined in the risk management rule if the calculated risk is above the defined threshold.

5. The article of manufacture of claim 2, wherein the process model is annotated with the probability during design time, the probability defined manually or automatically.

6. The article of manufacture of claim 5, wherein the process model is annotated by:
annotating an outgoing transition of an XOR gateway; and
annotating an outgoing transition of an AND gateway.

7. The article of manufacture of claim 4, wherein the risk management rule defines the initiating event, the risk event, the threshold, the impact, and the action.

8. A computerized method comprising:
receiving an initiating event from a monitoring unit for risk evaluation;
determining a risk event from a risk management rule for the initiating event;
for a plurality of process models, where the risk event can happen in future:
determining a plurality of instances of a process model from the plurality of process models;
for the plurality of instances of the process model:
locating a position of the risk event in an instance of the process model;
calculating a risk for the position of the risk event;
comparing the calculated risk against a threshold defined in the risk management rule; and
in response to compare the calculated risk, executing the risk management rule.

9. The method of claim 8, further comprising:
determining a first current execution state in the instance of the process model;
calculating probability of the risk event for the first current execution state; and
calculating the risk based on the calculated probability and an impact of the risk event.

10. The method of claim 9, further comprising:
calculating a maximum risk based on the calculated risk for the first current execution state and the calculated risk for a second current execution state.

11. The method of claim 9, wherein executing the risk management rule comprises executing an action defined in the risk management rule if the calculated risk is above the defined threshold.

12. The method of claim 9, wherein the process model is annotated with the probability during design time, the probability defined manually or automatically.

13. The method of claim 12, wherein the process model is annotated by:
annotating an outgoing transition of an XOR gateway; and
annotating an outgoing transition of an AND gateway.

14. The method of claim 11, wherein the risk management rule includes definitions of the initiating event, the risk event, the threshold, the impact, and the action.

15. A computing system comprising:
a monitoring unit to monitor an event and send the event for risk evaluation;
a process engine that provides a set of probabilities for the event to happen, the set of probabilities defined manually or automatically;
a risk management engine to perform the risk evaluation on the event following a process model, wherein the risk management engine defines and executes a risk management rule on the event and calculates risk for the event based on the set of probabilities and an impact of the event; and
a reaction engine to react on the event based on the risk calculation and an action defined in the risk management rule.

16. The computing system of claim 15, wherein the risk management rule includes definitions of the event, a risk event, a threshold, the impact, and the action.

17. The computing system of claim 16, wherein the risk event is part of the process model, from which a set of instances of the process model are created.

18. The computing system of claim 15, wherein the process model is annotated with the set of probabilities during design time.

19. The computing system of claim 16, wherein the event is described by an event type, an activity generating the event and an optional descriptor including data, resource, and services associated with the event or the activity.

20. The computing system of claim 15, wherein the threshold is a numerical value and is defined as smaller or greater to a risk value.
